(19) United States
(12) Patent Application Publication
(10) Pub. No.: US 2015/0294376 A1
(43) Pub. Date: Oct. 15, 2015

(54) A MARKETING METHOD AND SYSTEM UTILISING ELECTRONIC NETWORKING MEDIA

(71) Applicant: GUVERA IP PTY LTD, Robina, Queensland (AU)

(72) Inventor: Bradley John Christiansen, Robina (AU)

(21) Appl. No.: 14/647,797

(22) PCT Filed: Nov. 27, 2013
(86) PCT No.: PCT/AU2013/001371

§ 371 Date: May 27, 2015

(30) Foreign Application Priority Data
Nov. 27, 2012 (AU) 2012905153

(51) Int. Cl. G06Q 30/02; G06Q 50/00

(52) U.S. Cl. CPC G06Q 30/0277; G06Q 30/0217; G06Q 50/01

(57) ABSTRACT

A marketing method utilising electronic networking media, the method including the steps of providing a branded advertismg interface on a computer network to at least one user; offering the at least one user one or more incentives to provide a personal comment with brand identifying information related to the brand advertised on the branded interface, posting said personal comment with brand identifying information to a personal portion related to the user on at least one personal networking media; and posting said personal comment with brand identifying information to a corporate portion related to the brand advertised on the branded interface on at least one networking media.

### FIELD OF THE INVENTION

The present invention relates generally to marketing and particularly to utilising the nature of personal networking media to market products and services through referrals.

### BACKGROUND ART

Traditional advertising techniques include print and television advertising. The Internet had already overtaken television as the largest advertising market. Websites often include banner or pop-up ads. Social networking sites don't always have ads. In exchange, products have entire pages and are able to interact with users. Television commercials often end with a spokesperson asking viewers to view the product website for more information. Print ads are also starting to include barcodes or other identifiers on them. These barcodes can be scanned by cell phones and computers, directing viewers to the product website. Advertising is beginning to move viewers from the traditional outlets to the electronic ones.

The term social media refers to the use of web-based and mobile technologies to turn communication into interactive dialogue.

Social networking websites allow individuals to interact with one another and build relationships. When products or companies join those sites, people can interact with the product or company. That interaction feels personal, to users because of their previous experiences with social networking site interactions.

Social networking sites like Twitter, Facebook, YouTube and blogs allow individual followers to “retweet” or “repost” comments made by the product being promoted. By repeating the message, all of the users connections are able to see the message, therefore reaching more people. Social networking sites act as word of mouth. Because the information about the product is being put out there and is getting repeated, more traffic is brought to the product/company.

Through social networking sites, products/companies can have conversations and interactions with individual followers. This personal interaction can instill a feeling of loyalty into followers and potential customers. Also, by choosing whom to follow on these sites, products can reach, a very narrow target audience. This normally involves individuals “linking” to the sites of the brands that they would like to follow.

Various social networking media allow marketing of products or services to individuals with the nature and level of the marketing varying between the different channels. For example, Twitter allows companies to promote products on an individual level. The use of a product can be explained in short messages that followers are more likely to read. These messages appear on followers' home pages. Messages can link to the product's website, Facebook profile, photos, videos, etc. This link provides followers the opportunity to spend more time interacting with the product online. This interaction can create a loyal connection between product and individual and can also lead to larger advertising opportunities. Twitter promotes a product in real-time and brings customers in.

Facebook profiles are more detailed than Twitter. They allow a product to provide videos, photos, and longer descriptions. Videos can show when a product can be used as well as how to use it. It can include testimonials as other followers can comment on the product pages for others to see. Facebook can link back to the product's Twitter page as well as send out event reminders. Facebook promotes a product in real-time and brings customers in.

Blogs allow a product or company to provide longer descriptions of products or services. The longer description can include reasoning and uses. It can include testimonials and can link to and from Facebook and Twitter pages. Blogs can be updated frequently and are promotional techniques for keeping customers.

To date however, the social networking media are simply electronic substitutes for disseminating a brand message or providing an interface where a potential customer can interact with the product. Whilst the friends or linked members of a follower can see that the follower is also linked to a brand or corporate profile, there is no incentive for the follower to actively promote their opinion of the brand or product, it is more simply passive following of the brand or corporate profile.

Some corporate members of social networking channels have over one million members which are kept updated as to developments and changes in the products, services or offerings of the corporate member. There is very little leverage of these followings however to gain new followers nor to use the opinions of the existing followers to drive revenue creation.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a marketing method and system utilising electronic networking media, which may at least partially overcome at least one of the abovementioned disadvantages or provide the consumer with a useful or commercial choice.

With the foregoing in view, the present invention in one form, resides broadly in a marketing method utilising electronic networking media, the method including the steps of

1. Providing a branded advertising interface on a computer network, to at least one user;

2. Offering the at least one user one or more incentives to provide a personal comment with brand identifying information related to the brand advertised on the branded interface;

3. posting said personal comment with brand identifying information to a personal portion related to the user on at least one personal networking media; and

4. Posting said personal comment with brand identifying information to a corporate portion related to the brand advertised on the branded interface on at least one networking media.

In an alternative embodiment, the present invention resides broadly in a marketing system utilising electronic networking media, the system including

1. a branded advertising interface on a computer network offering at least one user one or more incentives to provide a personal comment with brand identifying information related to the brand advertised on the branded interface;

2. a networking location accessible via a network of computers to which the at least one user's personal comment with brand identifying information is posted to a personal portion related to the user on at least one personal networking media; and

3. a networking location accessible via a network of computers to which the at least one user's personal comment with brand identifying information is posted to a corporate portion related to the brand advertised on the branded interface on at least one networking media.

In still a further alternative embodiment, the invention resides in a computer program product carrying a computer program adapted to perform the marketing method utilising electronic networking media including the steps of:

1. Providing a branded advertising interface on a computer network to at least one user;

2. Offering the at least one user one or more incentives to provide a personal comment with brand identifying information related to the brand advertised on the branded interface;

3. posting said personal comment with brand identifying information to a personal portion related to the user on at least one personal networking media; and

4. Posting said personal comment with brand identifying information to a corporate portion related to the brand advertised on the branded interface on at least one networking media.

The computer program product carrying a computer program is preferably embodied in a computer readable medium adapted to perform the marketing method utilising electronic networking media.

The computer program product will typically be run or executed on a computer or network of computers. The computer program product and/or method will therefore typically be a computer implemented method or product.

The technical effect of implementing the method or product as a computer implemented method or product is preferably the publication (preferably the simultaneous publication) of the personal comment, with brand identifying information related to the brand advertised on the branded interface to both the user's personal portion related to the user on at least one personal networking media and the corporate portion related to the brand advertised on the branded interface on at least one personal networking media. This includes generation of an electronic data entry form for input of information, preferable parsing of the information entered and publication to the electronic networking media in more than one profile or portion.

Electronic networking media will typically be or include personal networking media or social networking media that generally has as a function of the media, the ability for third parties who are part of the user's network or a part of the corporate brand's network to view posts made to the personal portion related to the user and/or corporate portion related to the brand on the networking media. Typically, the comment, message or review formulated by the user will be published to “friends” or “followers” or whatever the connections or linked members of the user are termed. The method and system of the present invention is not limited to social networking media and other types of networking media can be used such as professional networking media or any networking media where members are linked to one another.

The method of the present invention includes the steps of providing a branded advertising interface on a computer network to at least one user. Typically, the branded advertising interface is provided by a party unrelated to the brand owner.

Typically, the branded advertising interface is provided as part of a website or other system that uses visit in order to obtain electronic content. One example of the typical provider of the branded advertising interface is a content provider such as a music download site or any other advertising system.

Typically, the branded advertising interface will include one or more pieces of content the user may wish to consume. In this context, the term “consume” can mean immediate consumption or delayed consumption. The term therefore includes downloading to a device as well as saving, printing or otherwise consuming content such as by viewing or listening.

Typically, the third-party provider of the advertising system will have an agreement with the brand owner to provide particular content to particular consumers having one or more target characteristics. The unrelated third-party provider will then typically generate the branded advertising interface in response to consumer queries.

Normally, the brand will be prominently displayed on the branded advertising interface. The brand owner will typically offer the content to the user for free and/or in response to actions taken by the user. The third-party provider may offer the content to the user and identify the brand or brand owner as the party bearing the cost of providing the content in order to create goodwill in the mind of the user on behalf of the brand.

Typically, the branded advertising interface will include identification of the particular content available that the brand is willing to pay for in order to provide to the user. There may be other restrictions on the provision of content to a user, such as user characteristics, content characteristics or brand characteristics. Typically all three will be matched in order to ensure that content is provided only to those satisfying a matching procedure that matches the brand owner's target characteristics with the user characteristics and the content characteristics.

The branded advertising interface is preferably generated according to a matching algorithm. One form of generation engine for generating a branded advertising interface is disclosed in International Patent Application No. PCT/AU2010/001692, the disclosure of which is incorporated herein by reference.

Typically, a list of the available content for which the brand is willing to pay to provide to a particular user is provided on an interface either beside, or superimposed over brand elements or having brand elements incorporated thereinto.

The brand elements may have any form including trademarks, either registered or unregistered, images of personalities associated with the brand or equipment associated with the brand or product of the brand in order to evoke brand identity and/or personality in the mind of the user.

The method of the present invention also includes offering an incentive to a user to provide a personal comment with brand identifying information relating to the brand advertised on the branded interface.

The incentive offered may take any form including the ability to gain points or credits or any other redeemable quantity that a user can use to gain content that they want. Typically, the incentive offered will be in the form of additional content from the provider.

The method will be such that the comment elicited or offered by the user will typically be positive. The comment offered by the user may undergo testing or validation in order to ensure the positivity of the comment. An algorithm may be used for this purpose. A variety of algorithms could possibly be used including one which checks words in the comment with a particular keyword list for presence on the keyword list and then either accepts the comment or discounts the comment depending on the presence or absence of words in comment from words in the keyword list. Therefore, the validation process may be a positive validation process or negative validation process.

Typically, one or more action prompts or buttons may be provided on the branded advertising interface. The action prompts or buttons may be associated with an identification of the incentive offered. More than one action prompt or button may be provided with different levels of incentive.

Typically, selection of an action prompt or button by the user launches an electronic data entry form for entry of information thereinto by the user in order to be or formulate a comment, message or review.

The data entry form preferred will be electronically produced. The form will typically allow for entry of the comment thereinto, typically using a keyboard or the like which will normally be provided with the device upon which the user accessed the system.

The size of the comment which may be entered into the form may be limited. Typically, the sizeable length of comments or “posts” to networking media are limited by the networking media provider. Therefore, the size of the comment which may be entered into the form may be limited according to which network or networks the comment is to be posted. A preferred length will be up to 420 characters.

The form may include identifying information identifying the user as the source of the comment, message or review. The method of the present invention requires identification of the user providing the comment on the networking media. This identifying information is preferably hard coded into the comment or post or may be populated according to user identification information obtained either from the branded advertising interface or from login details required in order to log in to a third-party provider website. This identifying information is preferably unalterable by the user.

The method of the present invention may also populate the brand from the branded advertising interface into the comment or post in order to ensure inclusion. This will obviate the need for the user to actively include the brand information in the review.

Preferably, the personal comment is content or message from the user. The content or message will typically form the basis for a “post” to the networking media.

The method or system of the present invention may provide a number of template messages to the user in order to allow the user to select a template comment. If a particular template is selected, the validation algorithm will typically not be used. The method and system of the present invention will typically allow for free-form messages from the user either together with the template message(s) or instead of.

One particularly preferred template message may be in the form of:

USERNAME has just downloaded CONTENT from BRAND. Thanks BRAND.

with USERNAME being replaced with the user's identifier, usually username, CONTENT being replaced by an identification of the content provided to the user (either entered by the user or populated from the user's selection of the content from the branded advertising interface) and BRAND being replaced by an identification of the brand providing the content to the user (either entered by the user or populated from the user's selection of the content from the branded advertising interface).

The comment may be or include this message.

Preferably, the data entry form will include an action prompt to allow the user to post the comment. A further action prompt allowing cancellation of the comment will typically be provided. The “post” action prompt will normally be selected by the user wants the message or comment has been created.

Once the user has “posted” as the comment with the brand identifying information, the message will typically be sent from the system to a personal portion of a networking media related to the user and also to a corporate portion of networking media related to the brand advertiser in the branded advertising interface at the same time.

This may not result in simultaneous posting of the message on the networking media but preferably this is the case. The posting of the message will also trigger the provision of the incentive to the user.

The structure of many networking media sites includes a profile. Profiles may be set up by individuals or by corporations, with these profiles been called personal profiles or corporate profiles respectively. Members of the networking media can join or link to a personal profile or corporate profile. Typically members of the networking media are joined or linked to a number of other profiles, with the member profiles typically being identifiable as being linked together from each of the respective profiles. For example, if USER1 is a friend of USER2, then the fact that these two are friends can be seen from both profiles. Typically, a third party can proceed from the profile of either USER1 or USER2, two the profile of the other. This is normally done by hyperlinking the respective profiles. Some users have many thousands or even millions of linked profiles.

The message may be posted on more than one networking media. Typically social networking media such as Facebook™ or Twitter™ are the intended networking media for the comment or message. There are other networking media available such as professional networking media, and the method and system of the present invention they used in relation to any networking media where there are multiple members and one member (individual or corporate) is linked to any one or more other members.

Preferably, the message, once posted, will be available for viewing by the user's friends or linked members. The message or comment may also provide a link back to the branded advertising interface or from a corporate portion to a personal portion of the networking media or vice versa.

An action prompt or button is typically provided for the user's friends or linked members to visit the branded advertising interface. If they are not members, then they may be prompted to join.

An action button may be provided to view information about the brand on the networking media, typically by linking to the brand's corporate profile.

Typically, the links are active links such as hyperlinks.

The message or comment is also preferably shared/published/posted to the corporate portion of profile related to the brand advertised. This will allow other linked members of the corporate profile to see that the user has posted a comment about the brand only corporate profile. This may allow individual users who are not linked members to see what other unrelated members think about the brand.

Normally, corporate portions will profiles will have similar functionality to personal portions or profiles but are accessible to friends or linked members of the brand owner.

In one embodiment, the system of the present invention is an advertising system. The system of the present invention will preferably be computer implemented. As such, the system will normally be implemented on at least one computer including one or more processors, storage means and associated with one or more communications pathways.

The system of the present invention may be implemented using devices with computer processors such as telephones, portable or desktop computers, personal data devices, MP3 and MP4 players, audiovisual storage and display devices, televisions and the like. Provided that a device that can access communications pathways for the downloading of content and transmit information allowing a user to devise and send messages, that device may be used according to the system of the present invention.

The present invention is particularly adapted for delivery of content to a user according to the request of a user over an electronic or digital network, to prompt the user to provide feedback or comment and then publish this feedback or comment to a wider audience to prompt more delivery of content and wider publication of a brand associated with that delivery. As such, it is particularly adapted for use in the field of television (subscriber or “pay” television or free to air), interne delivery, or even in flight entertainment (IFE) delivered to individual seats on a flight dependent upon the customer in that seat. According to the IFE embodiment, a customer will need to provide the system with customer parameters or login details to access customer parameters present in the system already in order for the system to recognize the customer. In this embodiment, the communications pathway is one between the customer's seat display or delivery mechanism and a database of the content and content is therefore “downloaded” from the database (normally a central database servicing the entire flight) to the customer's seat display or delivery mechanism. The present invention therefore may utilize an “open” communications network or a “closed” communications network.

Typically, the system and software product of the present invention will be located on a network of computers such as the Internet. Indeed, the system of the present invention will normally be accessed through a network of computers such as the Internet or a worldwide network.

Typically, the system of the present invention will be accessed through an interface provided as a webpage located on a worldwide network of computers and accessible using any form of display means to display the interface, and accept inputs and action the inputs appropriately. This includes computers, PDA's, mobile phones and the like. In this way, the system of the present invention can provide targeted advertising at a personal level to a large number of users simultaneously.

The system of the present invention is adapted to provide advertising of a brand through the provision of comments from a first user to other users based on the satisfaction of the first user with content provided by a particular brand through a link between that brand being associated with that content. Importantly, the brand association with the content will be a passive or non-disruptive association. The brand will be displayed on a custom produced and displayed interface bearing indicia representing the brand providing the content, but not disruptive, delaying or interrupting the content delivery. A user will typically find this enjoyable and will therefore be more likely to provide a positive comment regarding the brand.

Preferably, the system of the present invention will be implemented across any network and will typically be network independent, with no network prevented from access to the system but no network preferred either. Usually, a computer or similar device will be used to access the interface but personal communications devices such as telephones also have this capability.

The system of the present invention will normally have a system administrator. The system administrator will typically have access to all parts of the system and may have access through the same interface as the other members of the system was through a stand alone, or separate specialised interface. Normally, the system administrator will have access through the same interface with the level of access of the system administrator differentiated by access on login information which will distinguish the system administrator from other users or members. The system administrator will normally be responsible for ensuring that the branded interface be presented and that the content displayed or accessible through that interface be appropriate to represent the brand persona.

The pieces of content should be considered to be anything of intrinsic or implied value that a user can “consume” specifically including but not limited to, music, audio, video, books or ebooks, games, applications (or “apps”), software “add-ons”, still images, snippets, services, redeemable vouchers, branded material, t-shirts, caps, tickets to events, information services or portions of the aforementioned.

For the purposes of the present description, the term “consume” includes downloading the content whether for immediate or delayed consumption, printing, or saving the content.

Basically, the content can have any form provided that the content is electronic or digital in order that the content can be transmissible between the system and the at least one consumer and between the at least one content provider and the system. Normally, each piece of content will be stored in an electronic file and it is this electronic file which will typically be capable of transmission, dissemination or copying or the like onto a physical medium.

The content will typically be provided from any source. For example, an entertainment studio, TV network, Internet social networking systems or record labels may choose to provide content to the system. Alternatively, smaller organisations or individuals may choose to provide content directly to the system such as home movies, demo music tracks or the like.

Authentication of identity systems may be used in conjunction with the system of the present invention. There are many of these systems available and any may be used to authenticate the identity of members of any of the groups associated with the system. The authentication system will typically be integrated with the transaction system and the consumer request, uploading of content and provision of content sub-systems.

The method of the present invention is preferably used in concert with a computer implemented method for producing and displaying content representing a brand persona, the method including the steps of:

1. providing at least one consumer database containing a plurality of consumer profiles with consumer preference identifying data stored on a data storage device,

2. providing at least one brand database containing details of brand clients, each having one or more branding parameters stored on a data storage device,

3. providing at least one content database containing a plurality of pieces of content provided by at least one content provider with each piece of content having one or more content profile identifiers stored on a data storage device,

4. a brand specific interface accessible by at least one consumer, the brand specific interface generated by a data processor by matching at least one branding parameter of a brand client with one or more pieces of content and displaying the pieces of content on a branded interface presented to a consumer at no cost to the consumer whilst charging an advertising fee to the brand client and paying a content provision fee to the content provider, the content provided without branding disrupting or interrupting the content.

Alternatively, the system of the present invention is preferably used in concert with a computer implemented brand specific interface generating system for producing and displaying content representing a brand persona, the system including:

1. at least one consumer database containing a plurality of consumer profiles with consumer preference identifying data stored on a data storage device,

2. at least one brand database containing details of brand clients, each having one or more branding parameters stored on a data storage device,

3. at least one content database containing a plurality of pieces of content provided by at least one content provider with each piece of content having one or more content profile identifiers stored on a data storage device, and

4. a brand specific interface generation engine operating in association with a data processor, and which generates the brand specific interface by matching at least one branding parameter of a brand client with one or more pieces of content and displays the pieces of content on a branded interface presented to a consumer at no cost to the consumer whilst charging an advertising fee to the brand client and paying a content provision fee to the content provider, the content provided without branding disrupting or interrupting the content.

The brand specific interface is generated to display content drawn from a larger pool of content based on parameters set by a particular brand client with each piece of content provided to a consumer conveying a brand persona which the brand client wishes to convey to the consumer to build brand loyalty.

Preferably, the brand interface will contain passive identification of the brand only. It is preferred that any advertising is not embedded or interspersed with any piece of content. Further, the advertising will not require display before, during or after the content but will be passively delivered either through a branded interface and/or through provision of brand matched content having particular consumer contextual tagging to provide a consumer with brand association.

Any of the features described herein can be combined in any combination with any one or more of the other features described herein within the scope of the invention.

### BRIEF DESCRIPTION OF THE DRAWINGS

Various embodiments of the invention will be described with reference to the following drawings, in which:

FIG. 1 is a schematic view of the hardware used to implement the method of a preferred embodiment of the present invention.

FIG. 2 is a schematic view of the process followed in implementing the method of a preferred embodiment of the present invention.

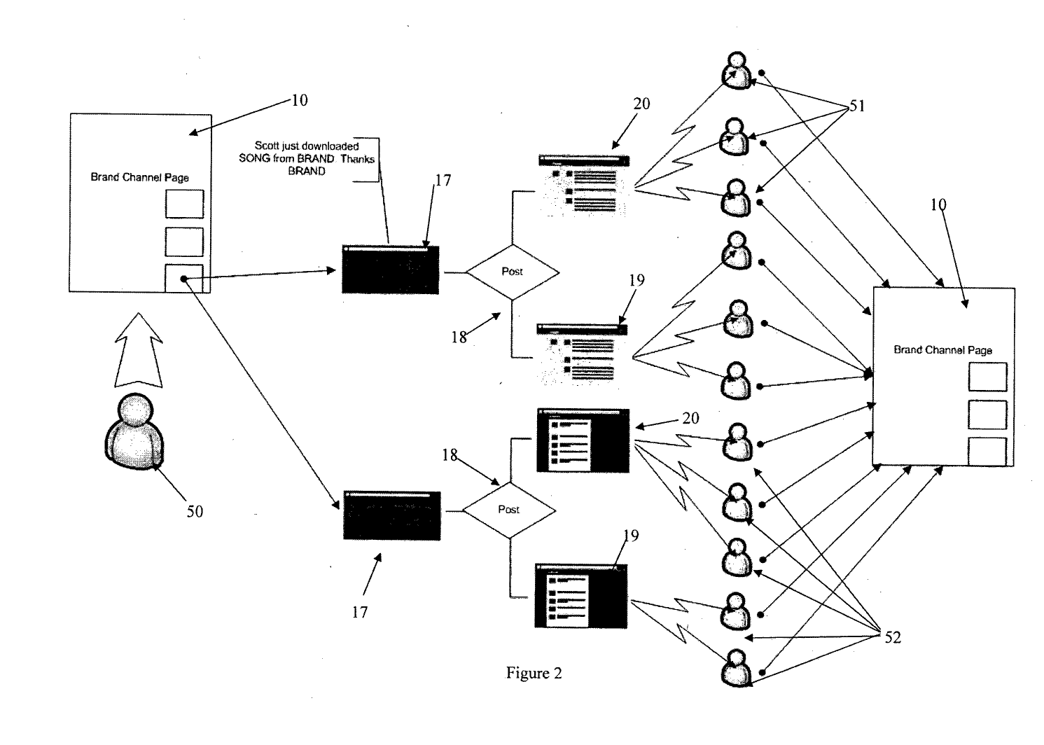

FIG. 3 is a schematic view of a brand specific interface according to a preferred embodiment of the present invention.

### DETAILED DESCRIPTION OF THE PREFERRED EMBODIMENT

According to a particularly preferred embodiment of the present invention, a marketing system utilizing electronic social networking media is provided.

The marketing system of the preferred embodiment is implemented as a part of an advertising system which includes at least one consumer database containing a plurality of consumer profiles with consumer preference identifying data, at least one brand database containing details of brand clients, each having one or more branding parameters, at least one content database containing a plurality of pieces of content provided by at least one content provider with each piece of content having one or more content profile identifiers, and a content matching engine which matches the branding parameters of the brand clients with one or more of pieces of content and provides these pieces of content to one or more consumers upon the consumer request, based on the matching of the branding parameters and the consumer preference identifying data at no cost to the consumer whilst charging an advertising fee to the brand client and paying a content provision fee to the content provider.

This advertising system is a transactional model allowing entertainment content to be bought and sold over a digital interface, examples of which include web interfaces, mobile networks and digital television. The transactional model is linked to the system database which tracks the content transacted, enables payment to content owners and importantly, enables consumer brands to build campaigns that target consumers. The system can be used to buy and sell physical media upon which entertainment content is stored as well as electronic content or content available in electronic form.

Entertainment content will typically be free to consumers to consume as advertisers will pay a per download fee to the entertainment owners for each file that their target consumers download. The reason advertisers will pay for each file download is because they will have the opportunity to build a unique relationship with their targeted consumers.

The content matching engine will preferably match the content with one or more brands based on the personality of each and then provide the brand matched content to the consumer at no cost to the consumer in order that the brand can build an association with the consumer through the content. Typically, the content when provided to the consumer will identify or be identified as being provided to the consumer free of charge on behalf of the matching brand client or brand in order to build affinity with the brand in the mind of the consumer.

Te advertising system will typically utilise a computer implemented brand specific interface generating system for producing and displaying content representing a brand persona. The system includes at least one consumer database containing a plurality of consumer profiles with consumer preference identifying data stored on a data storage device, at least one brand database containing details of brand clients, each having one or more branding parameters stored on a data storage device, at least one content database containing a plurality of pieces of content provided by at least one content provider with each piece of content having one or more content profile identifiers stored on a data storage device, and a brand specific interface generation engine operating in association with a data processor, and which generates the brand specific interface by matching at least one branding parameter of a brand client with one or more pieces of content and displays the pieces of content on a branded interface presented to a consumer at no cost to the consumer whilst charging an advertising fee to the brand client and paying a content provision fee to the content provider, the content provided without branding disrupting or interrupting the content.

The generation engine will typically operate according to one of two types of queries from a user who is a member of advertising system.

The first type of query may be a consumer brand query in which a consumer searches for a particular brand. The brand specific interface generation engine then searches for the brand client and examine the brand client parameters. The generation engine will then typically search the content database for content which matches the brand parameters. The generation engine will typically search a variety of different content types and selects a random combination of matching content from the pool. The generation engine in uses this random combination to generate an interface displaying the brand and the selected pieces of content. The consumer may then view or display content from this interface.

The second type of query may be a consumer query for content where the consumer requests particular content. According to this aspect, the brand specific interface generation engine will search to find the particular content piece, then typically identify the content tags of the particular content requested and search the brand database for brand clients which are providing that content piece. The interface generation engine then checks to see whether the consumer identification data matches the brand parameters. If there is a match, that brand is added to a displayed list and the search moves on. If there is no match, the brand is dropped and the search moves on.

Once the brand list has been finalised (which may be through a search of all brands or simply a certain number of brands or simply a certain number of certain type or of a certain type of brand) the list is provided to the consumer.

The consumer then typically chooses a brand to provide the content requested. The brand specific interface generation engine then preferably searches the brand client for its brand parameters. The generation engine then preferably uses those brand parameters and the consumer content query in order to select pieces of content from a content pool and generates a brand specific interface which includes the requested content and/or other content which matches the content tags for the content requested as well as the brand parameters for the brand providing the content requested.

The brand is preferably also displayed on the interface. Typically, the brand is provided without advertising specific to that brand. Where provided, advertising is non disruptive or passive advertising. The brand association with the content will be a passive or non-disruptive association. The brand is displayed on a custom produced and displayed interface, bearing indicia representing the brand providing the content, but not disrupting, delaying or interrupting the content delivery.

Typically, charging occurs when the consumer downloads or views the content and a brand client is not charged for the display of the content on the interface.

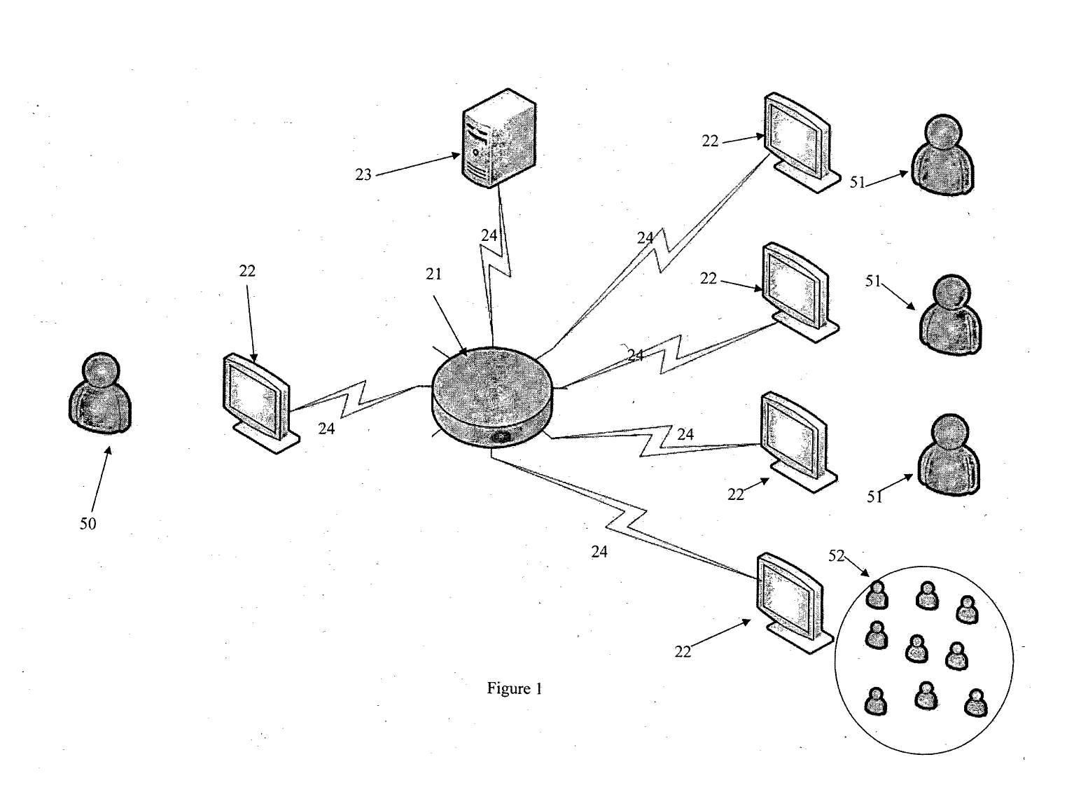

The system to this point is typically a prior art system operating on a network 21, a very generic form of is illustrated in FIG. 1. The schematic illustrated therein includes a user 50 with a device 22 adapted to access the network 21. A server 23 or similar operated by the administrator of the advertising system also has access to the network 21 to control the generation of the interfaces and the method of the invention.

A variety of other users, including linked members of friends 51 of the user 50 on social network channels also have access to the network 21 as do other users who are linked members of friends 52 of a corporate or brand member.

Communications pathways 24 are provided between the different devices which form the system.

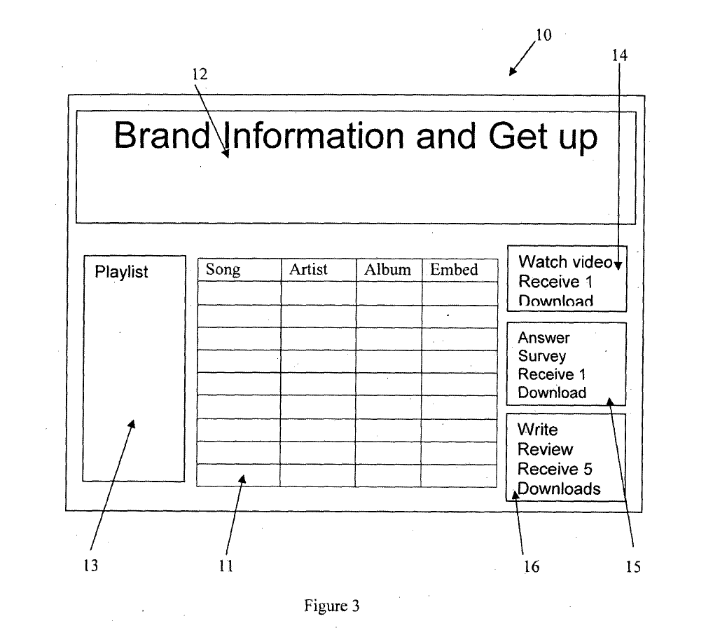

A schematic example of a preferred brand specific interface 10 utilised according to the present is illustrated in FIG. 3. The process is followed as outlined above but the preferred brand specific interface 10 is generated including a list 11 of the available content for which the brand is willing to pay for a particular user including title, artist and album provided on an interface either beside, or superimposed over brand elements 12 or having brand elements incorporated into the interface. The entire interface will normally be generated to reflect the brand persona, whether it contains direct references or not. Other elements may be included such as a user playlist 13 to which content can be added, deleted and reordered.

The interface is normally provided as an interactive interface whereby a user/consumer 50 can choose to play or download or otherwise interact with the content or branding on the interface by selection.

The consumer 50 can choose delivery of any of the content on the interface and the content is provided. The interface also contains additional content related to that requested and which also conveys the brand persona. In this way the consumer 50 is provided with additional content that may convey the brand persona to them or positively reinforce the brand in the mind of the consumer. In this way the consumer 50 is delivered the content contemporaneously with the branding rather than after or interspersed with the branding.

When the preferred brand specific interface 10 is generated, the interface includes one or more action prompts or buttons associated with an identification of an incentive which could be gained by the user 50 in return for providing a personal comment or message.

According to the preferred embodiment illustrated in FIG. 3, three incentive action prompts or buttons are provided, a first incentive action prompt or button 14 offering the user 50 a chance to gain 1 extra download if they choose to watch a video (typically related to the brand advertised but possibly in relation to other unrelated information), a second incentive action prompt or button 15 offering the user 50 a chance to gain 1 extra download if they choose to answer a survey (again typically related to the brand advertised but possibly in relation to any other product, service, company or opinion of the user) and a third incentive action prompt or button 16 offering the user 50 a chance to gain 5 extra downloads if they write and post a personal comment or message. The downloads will normally be provided through the advertising system referred to above.

The user 50 may be able to utilize the incentive program offered to gain credits or other value tokens, usually funded by the brand advertised, and provided to an account or similar in the control of the user.

The selection of an action prompt or button 14, 15, 16 by the user launches an electronic data entry form 17 for completion by the user 50.

The data entry form 17 is electronically produced and displayed on an interface, normally a new interface or “pop-up” window.

There are two preferred embodiments as to the manner is which the message is created. The first preferred embodiment is a free form comment and in this form, the data entry form 17 allows entry of the comment therein to, typically using a keyboard or the like.

The size of the comment which may be entered into the form is normally limited. Typically, the size or length of comments or “posts” to networking media are limited by the networking media provider. Therefore, the size of the comment which may be entered into the data entry form is limited according to which network or networks the comment is to be posted. The preferred embodiment illustrated in FIG. 3 illustrates a message or comment which is posted to two different social media channels 18 to a corporate profile 19 and a personal profile 20 in each.

According to a second preferred embodiment, the method or system of the present invention may provide a number of template messages to the user in order to allow the user to select a template comment.

One particularly preferred template may be in the form of:

USERNAME has just downloaded CONTENT from BRAND. Thanks BRAND.

with USERNAME being replaced with the user's username (preferably automatically), CONTENT being replaced by an identification of the content provided to the user (either entered by the user or populated from the user's selection of the content from the branded advertising interface) and BRAND being replaced by an identification of the brand providing the content to the user (either entered by the user or populated from the user's selection of the content from the branded advertising interface).

The comment may be or include this message.

The comment elicited or offered by the user 50 should be positive and the comment offered by the user may undergo testing or validation in order to ensure the positivity of the comment. An algorithm will usually be used for this purpose. A variety of algorithms could possibly be used including one which checks words in the comment with a particular keyword list for presence on the keyword list and then either accept the comment or discounts the comment depending on the presence or absence of words in comment from words in the keyword list. Therefore, the validation process may be a positive validation process or negative validation process.

If a template comment is selected, the validation algorithm is typically not used.

The method and system of the present invention may allow for free-form messages from the user together with the template message(s) allowing a user to choose between the two methods of message creation.

The method of the present invention requires identification of the user providing the comment on the networking media. This identifying information is preferably hard coded into the comment or post or may be populated according to user identification info obtained either from the branded advertising interface or from login details required in order to blocking to a third-party provider website. This identifying information is preferably unalterable by the user.

The preferred embodiment of the method of the present invention will also populate the brand from the branded advertising interface into the comment or post in order to ensure inclusion. This will obviate the need for the user to actively include the brand information in the review.

The personal comment is content or message from the user. The content or message forms the basis for a “post” to the networking media and the brand is included positively to make use of the popularity of the networking media to spread the brand message and increase the linked members opinion of the brand.

The data entry form 17 includes an action prompt to allow the user to post the comment when the comment has been formulated. Further, an action prompt allowing cancellation of the comment is also normally provided. The “post” action prompt will normally be selected by the user wants the message or comment has been created.

Once the user has “posted” the comment with the brand identifying information, the message will typically be simultaneously sent from the system to a personal profile 20 of a networking media related to the user 50 and also to a corporate portion 19 of networking media related to the brand advertiser in the branded advertising interface.

This may not result in simultaneous posting of the message on the networking media but preferably this is the case. The posting of the message also triggers the provision of the incentive to the user.

The structure of many networking media sites includes a profile for each user or member. Profiles may be set up by individuals or by corporations, with these profiles been called personal profiles or corporate profiles respectively. Members of the networking media can join or link to a personal profile or corporate profile. Typically members of the networking media are joined or linked to a number of other profiles, with the member profiles typically being identifiable as being linked together from each of the respective profiles. For example, if USER1 is a friend of USER2, then the fact that these two are friends can be seen from both profiles. Typically, a third party can proceed from the profile of either USER1 or USER2, to the profile of the other. This is normally done by hyperlinking the respective profiles. Some users have many thousands or even millions of linked members.

According to the preferred embodiment, the message formulated by the user 50 in order to gain the incentive may be posted on more than one networking media. Typically social networking media such as Facebook™ or Twitter™ are the intended networking media for the comment or message. There are other networking media available such as professional networking media, and the method and system of the present invention they used in relation to any networking media where there are multiple members and one member (individual or corporate) is linked to any one or more other members.

The message, once posted, is available for viewing by the user's friends 51 or linked members. The message or comment may also provide a link back to the branded advertising interface 10 or from a corporate portion to a personal portion or vice versa of the networking media. Normally, an update message is sent to the user's contact list whenever a new post is made by the user notifying the user's linked contacts that an update has been made.

An action prompt or button is typically provided with the message to the user's friends or linked members in order to allow the users friends 51 to visit the branded advertising interface 10.

An action button may be provided to view information about the brand on the networking media, typically by linking to the brand's corporate profile.

Typically, the links are active links such as hyperlinks.

The message or comment is also shared/published/posted to the corporate profile 19 related to the brand advertised. This will allow other linked members of friends 52 of the corporate profile 19 to see that the user 50 has posted a comment about the brand owner's corporate profile. This may allow individual users who are not linked directly to the members posting the messages, to see what other unrelated members think about the brand.

Normally, corporate profiles 19 have similar functionality to personal profiles 20 but are accessible to friends or linked members of the brand owner.

The present invention allows a brand owner to make use of networking media to advertise and widen their target base by involving individuals and providing the means by which the brand owner can leverage an individual's opinion with their friends and associates.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least, one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A marketing method utilising electronic networking media, the method including the steps of:
a. Providing a branded advertising interface on a computer network to at least one user;
b. Offering the at least one user one or more incentives to provide a personal comment with brand identifying information related to the brand advertised on the branded interface;
c. posting said personal comment with brand identifying information to a personal portion related to the user on at least one personal networking media; and
d. Posting said personal comment with brand identifying information to a corporate portion related to the brand advertised on the branded interface on at least one networking media.

2. A marketing system utilising electronic networking media, the system including
a. a branded advertising interface on a computer network offering at least one user one or more incentives to provide a personal comment with brand identifying information related to the brand advertised on the branded interface;
b. a networking location accessible via a network of computers to which the at least one user's personal comment with brand identifying information is posted to a personal portion related to the user on at least one personal networking media; and
c. a networking location accessible via a network of computers to which the at least one user's personal comment with brand identifying information is posted to a corporate portion related to the brand advertised on the branded interface on at least one networking media.

3. A computer program product carrying a computer program adapted to perform the marketing method utilising electronic networking media including the steps of
a. Providing a branded advertising interface on a computer network to at least one user;
b. Offering the at least one user one or more incentives to provide a personal comment with brand identifying information related to the brand advertised on the branded interface;
c. posting said personal comment with brand identifying information to a personal portion related to the user on at least one personal networking media; and
d. Posting said personal comment with brand identifying information to a corporate portion related to the brand advertised on the branded interface on at least one networking media.
